(19) United States
(12) Patent Application Publication
(10) Pub. No.: US 2025/0239710 A1
(43) Pub. Date: Jul. 24, 2025

(54) MULTI-FUNCTIONAL SIDE-BEAM ASSEMBLY FOR STRUCTURAL BATTERY

(71) Applicant: GM Global Technology Operations LLC, Detroit, MI (US)

(72) Inventors: Goro Tamai, Bloomfield Hills, MI (US); Xianfeng Yan, Clawson, MI (US); Leopoldo Spindola, Lake Orion, MI (US); Maxwell Watts, Troy, MI (US); Giles D. Bryer, Northville, MI (US); Jordan Ladd, Royal Oak, MI (US)

(73) Assignee: GM Global Technology Operations LLC, Detroit, MI (US)

(21) Appl. No.: 18/416,514

(22) Filed: Jan. 18, 2024

(51) Int. Cl. H01M 50/244; H01M 50/249; H01M 50/367

(52) U.S. Cl. CPC H01M 50/244; H01M 50/249; H01M 50/367; H01M 2220/20

(57) ABSTRACT

A vehicular rocker rail includes an extruded member configured for mounting at a vehicle equipped with the vehicular rocker rail. The extruded member includes a first side, a second side opposite the first side, and an upper side and a lower side respectively extending between the first side and the second side. The first side, with the extruded member mounted at the vehicle, extends along a battery cell of the vehicle. The extruded member defines a venting chamber. A cell vent is formed through the first side. The cell vent is configured to, with the extruded member mounted at the vehicle, fluidly connect the battery cell and the venting chamber. A pack vent is formed through the lower side. The pack vent is configured to, with the extruded member mounted at the vehicle, fluidly connect the venting chamber to an exterior of the vehicle at the lower side.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to structural battery assemblies for vehicles, and more particularly, to cell-to-pack (CTP) and cell-to-body (CTB) structural battery assemblies. Specifically, the present disclosure provides a side beam structure for a structural battery assembly that provides longitudinal structural support for the battery assembly and provides a rocker rail structure for the vehicle. The side beam structure includes one or more first vents configured to fluidly couple a venting chamber of the side beam structure to one or more battery cells of the battery assembly and one or more second vents configured to fluidly couple the venting chamber to an exterior of the vehicle at a lower side of the side beam structure.

Battery powered vehicles, such as electric vehicles (EVs) and plug-in hybrid vehicles (PHEVs), are commonly equipped with structural battery packs that are integrated with the chassis or frame of the vehicle. These battery packs typically include a plurality of battery cells. A battery pack thermal runaway situation can occur when an individual cell inside the battery pack fails, such as due to physical impact during a vehicle collision or due to short circuit. During a thermal runaway event, failure of one battery cell can cause failure of additional battery cells, such as due to exposure of the additional battery cells to hot gas, flames, and particulates expelled from the failed battery cell.

To reduce the effect of a failed battery cell on additional battery cells in the battery assembly, a side beam structure of the battery assembly includes an extruded member defining a venting chamber. A first vent formed through the extruded member is configured to fluidly connect one or more battery cells of the battery assembly to the venting chamber and a second vent formed through the extruded member is configured to fluidly connect the venting chamber to the exterior of the vehicle. Thus, during thermal runaway of a battery cell, hot gas, flames, and/or particulates expelled from the failed battery cell are directed through the first vent and the venting chamber and out of the second vent away from the battery assembly, reducing or eliminating the effect of the failed battery cell on additional battery cells in the assembly.

### SUMMARY

One aspect of the disclosure provides a vehicular rocker rail. The vehicular rocker rail includes an extruded member configured for mounting at a vehicle equipped with the vehicular rocker rail. The extruded member includes a first side, a second side opposite the first side, and an upper side and a lower side respectively extending between the first side and the second side. The first side, with the extruded member mounted at the vehicle, extends along a battery cell of the vehicle. The extruded member defines a venting chamber. A cell vent is formed through the first side. The cell vent is configured to, with the extruded member mounted at the vehicle, fluidly connect the battery cell and the venting chamber. A pack vent is formed through the lower side. The pack vent is configured to, with the extruded member mounted at the vehicle, fluidly connect the venting chamber to an exterior of the vehicle at the lower side.

Implementations of the disclosure may include one or more of the following optional features. In some implementations, the cell vent and the pack vent are spaced from one another along a longitudinal axis of the extruded member. In some examples, the extruded member includes one or more baffles within the venting chamber between the cell vent and the pack vent. In some aspects, with the extruded member mounted at the vehicle, a vent chimney extends from the battery cell through the cell vent and at least partially into the venting chamber to fluidly connect the battery cell and the venting chamber.

In some implementations, the vehicular rocker rail further includes a flood port formed through the second side. The flood port is configured to, with the extruded member mounted at the vehicle, fluidly connect the venting chamber to the exterior of the vehicle at the second side. In further implementations, the vehicular rocker rail further includes a bussing vent formed through the first side. The bussing vent is configured to, with the extruded member mounted at the vehicle, fluidly connect a bussing region at the battery cell to a flood chamber of the extruded member. The flood port is further configured to, with the extruded member mounted at the vehicle, fluidly connect the flood chamber to the exterior of the vehicle at the second side.

In some examples, with the extruded member mounted at the vehicle, the extruded member extends along a first side of the battery cell and the extruded member is connected to a front beam that extends along a front side of the battery cell, a rear beam that extends along a rear side of the battery cell, an upper panel that extends along an upper side of the battery cell, and a lower panel that extends along a lower side of the battery cell. In further examples, the lower panel includes a skid rail that, with the extruded member mounted at the vehicle, extends along a longitudinal axis of the extruded member. The pack vent is configured to fluidly connect the venting chamber to an exhaust chamber of the skid rail. In other further examples, with the extruded member mounted at the vehicle, a center beam extends along a second side of the battery cell opposite the first side of the battery cell. The center beam defines a central venting chamber and the center beam includes a central cell vent configured to fluidly connect the battery cell and the central venting chamber and a central pack vent configured to fluidly connect the central venting chamber to the exterior of the vehicle at a lower side of the center beam. In some aspects, with the extruded member mounted at the vehicle, a vehicular body member is mounted at the second side.

Another aspect of the disclosure provides a vehicular battery assembly. The vehicular battery assembly includes a battery cell configured to, with the battery assembly mounted at a vehicle equipped with the vehicular battery assembly, power a propulsion system of the vehicle. A front beam extends along a front side of the battery cell. A rear beam extends along a rear side of the battery cell opposite the front side of the battery cell. An upper panel extends along an upper side of the battery cell. The upper side of the battery cell extends between the front side and the rear side of the battery cell. A lower panel extends along a lower side of the battery cell opposite the upper side of the battery cell. A first rocker rail extends along a first side of the battery cell. The first side of the battery cell extends between the front side and the rear side of the battery cell. A second rocker rail extends along a second side of the battery cell opposite the first side of the battery cell. The first rocker rail and the second rocker rail each respectively include an extruded member that includes a first side, a second side opposite the first side, and an upper side and a lower side respectively extending between the first side and the second side. The first side extends along the respective side of the battery cell. The extruded member defines a venting chamber. Each of the first rocker rail and the second rocker rail includes a cell vent formed through the first side. The cell vent fluidly connects the battery cell and the venting chamber. Each of the first rocker rail and the second rocker rail includes a pack vent formed through the lower side. The pack vent fluidly connects the venting chamber to an exterior of the vehicle at the lower side of the extruded member. This aspect may include one or more of the following optional features.

In some aspects, the cell vent and the pack vent are spaced from one another along a longitudinal axis of the extruded member. In some implementations, the extruded member includes one or more baffles within the venting chamber between the cell vent and the pack vent. In some examples, a vent chimney extends from the battery cell through the cell vent and at least partially into the venting chamber to fluidly connect the battery cell and the venting chamber.

In some aspects, the first rocker rail and the second rocker rail each respectively includes a flood port formed through the second side of the extruded member. The flood port fluidly connects the venting chamber to the exterior of the vehicle at the second side of the extruded member. In further aspects, the first rocker rail and the second rocker rail each respectively includes a bussing vent formed through the first side of the extruded member. The bussing vent fluidly connects a bussing region at the battery cell to a flood chamber of the extruded member. The flood port fluidly connects the flood chamber to the exterior of the vehicle at the second side of the extruded member. In some implementations, with the vehicular battery assembly mounted at the vehicle, a respective vehicular body member is mounted at the second sides of the extruded members.

Yet another aspect of the disclosure provides a vehicle. The vehicle includes a battery assembly. The battery assembly includes a battery cell that powers a propulsion system of the vehicle. A front beam extends along a front side of the battery cell. A rear beam extends along a rear side of the battery cell opposite the front side of the battery cell. An upper panel extends along an upper side of the battery cell. The upper side of the battery cell extends between the front side and the rear side of the battery. A lower panel extends along a lower side of the battery cell opposite the upper side of the battery cell. A first rocker rail extends along a first side of the battery cell. The first side of the battery cell extends between the front side and the rear side of the battery cell. A second rocker rail extends along a second side of the battery cell opposite the first side of the battery cell. The first rocker rail and the second rocker rail each respectively includes an extruded member that includes a first side, a second side opposite the first side, and an upper side and a lower side respectively extending between the first side and the second side. The first side extends along the respective side of the battery cell. The extruded member defines a venting chamber. Each of the first rocker rail and the second rocker rail includes a cell vent formed through the first side. Thee cell vent fluidly connects the battery cell and the venting chamber. Each of the first rocker rail and the second rocker rail includes a pack vent formed through the lower side. The pack vent fluidly connects the venting chamber to an exterior of the vehicle at the lower side. This aspect may include one or more of the following optional features.

In some aspects, the extruded member includes one or more baffles within the venting chamber between the cell vent and the pack vent. In some implementations, the lower panel includes respective skid rails that extend along respective longitudinal axes of the extruded members. The respective pack vents fluidly connect the venting chamber to respective exhaust chambers of the skid rails.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is an upper perspective view of a battery assembly for powering a propulsion system of a vehicle.

FIG. 2 is a sectional view taken along line 2-2 of FIG. 1.

FIG. 2A is an enlarged view of area 2A of FIG. 2.

FIG. 2B is an enlarged view of area 2B of FIG. 2.

FIG. 3A is a sectional view taken along line 3-3 of FIG. 1.

FIG. 3B is another sectional view taken along line 3-3 of FIG. 1.

FIG. 4 is a lower perspective view of the battery assembly.

FIG. 5 is a sectional view taken along line 5-5 of FIG. 1.

FIG. 6 is another upper perspective view of the battery assembly.

FIG. 7A is a perspective sectional view of area 7 of FIG. 6.

FIG. 7B is another sectional view of area 7 of FIG. 6.

FIG. 8 is another upper perspective view of the battery assembly.

FIG. 9A is an enlarged view of the battery assembly at area 9 of FIG. 8, with the rear beam removed from the battery assembly.

FIG. 9B is an enlarged view of the rear beam at area 9 of FIG. 8.

FIG. 10 is a rear perspective view of the battery assembly.

FIG. 11 is a perspective view of a venting chimney of a battery cell of the battery assembly.

FIG. 12 is a sectional view of a battery assembly with a vehicular body member mounted to an outer side of the side beam of the battery assembly.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

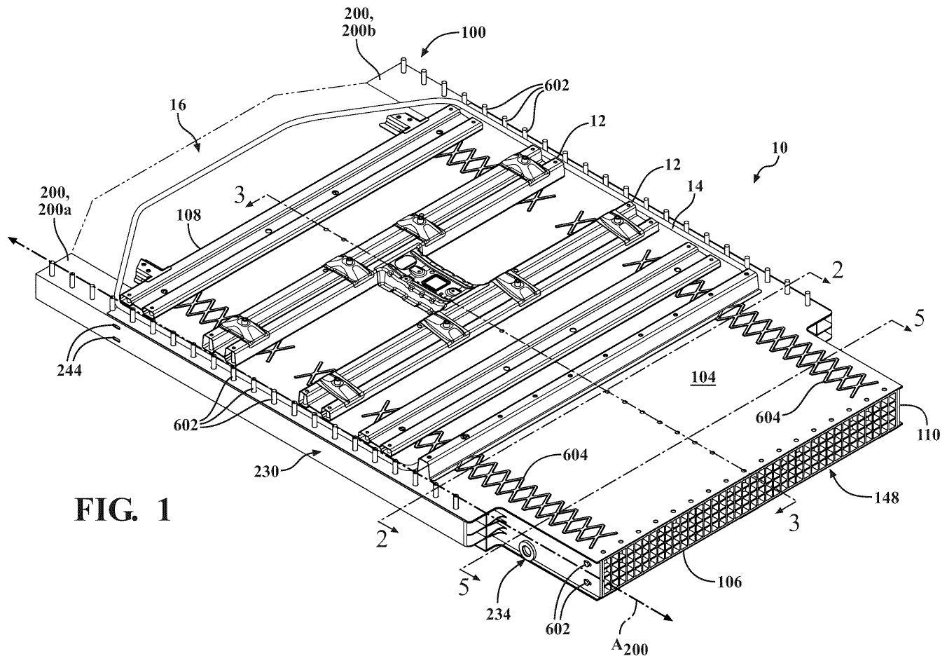

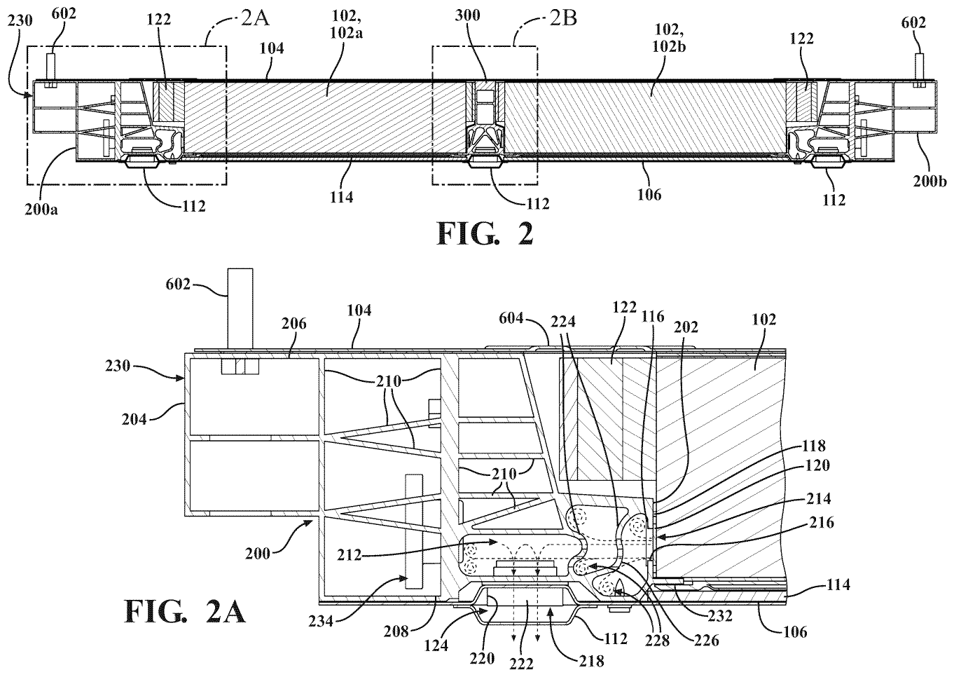

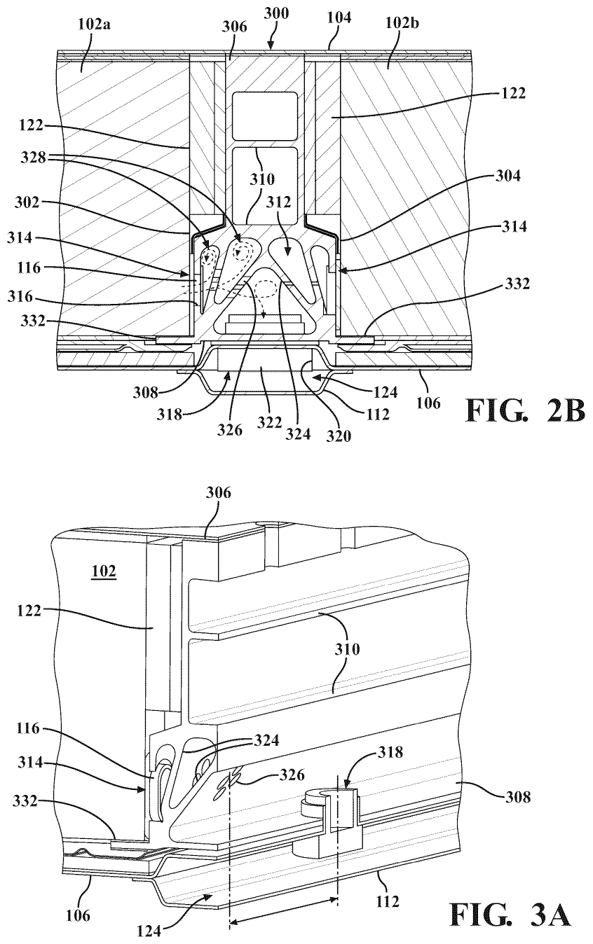

Referring now to the figures and the illustrated configurations depicted therein, a structural battery assembly or battery pack 100 for powering a propulsion system of a battery powered vehicle 10, such as an electric vehicle (EV) or plug-in hybrid vehicle (PHEV), includes a plurality of battery cells 102, 102a-b received between an upper panel 104 and a lower panel 106 (FIGS. 1 and 2). In the illustrated example, the battery assembly 100 includes a first battery cell (or first row of battery cells) 102a and a second battery cell (or second row of battery cells) 102b, and it should be understood that the battery assembly 100 may include any suitable number of battery cells 102 for powering the propulsion system of the vehicle 10. A front end-beam 108 extends along a front side of the battery cells 102 and seals a front end of the battery assembly 100 and a rear end-beam 110 extends along an opposite rear side of the battery cells 102 and seals a rear end of the battery assembly 100. As discussed further below, the battery cells 102, the front end-beam 108, and the rear end-beam 110 are disposed between a first side-beam or rocker rail 200, 200a and a second side-beam or rocker rail 200, 200b, where the respective rocker rails 200 provide longitudinal support members for the battery assembly 100 and may provide body rocker rails along respective sides of the vehicle 10.

With the battery assembly 100 mounted at the vehicle 10, the upper panel 104 is coupled to and extends between the rocker rails 200 and along an upper side of the battery cells 102 to form a floor of the vehicle body. That is, components for the vehicle cabin, such as rails 12 for mounting seats of the vehicle 10 and a vehicle wire harness 14, may be disposed along an upper or outer side of the upper panel 104 and/or mounted to the structural members of the battery assembly 100. Similarly, the lower panel 106 is coupled to and extends between the rocker rails 200 and along a lower side of the battery cells 102 to provide a lower exterior surface of the vehicle 10. For example, the lower panel 106 may include one or more skid rails 112 extending from a lower or outer side of the lower panel 106 for reducing damage to the battery assembly 100 and vehicle 10 during vehicle travel in low ground clearance situations. One or more thermal elements 114, such as a cold plate, thermal adhesive, and the like, may be disposed between the battery cells 102 and the lower panel 106 and/or upper panel 104 for improving thermal transfer away from the battery cells 102 and thus improving cooling of the battery assembly 100.

The front end-beam 108 and the rear end-beam 110 provide cell-stack compression plates and are clamped between the first rocker rail 200a and the second rocker rail 200b. Thus, with the first rocker rail 200a and the second rocker rail 200b functioning as the body rockers of the vehicle 10, the rocker rails 200 seal the side walls of the battery assembly 100 and provide a progressive cross-vehicle structure. The front end-beam 108 and the rear end-beam 110 seal the front and rear walls of the battery assembly 100 and provide cross-vehicle load transfer. A portion of the rocker rails 200 may extend beyond the front end-beam 108 to provide mounting space 16, such as for contactors, wiring, and other components associated with the battery assembly 100. Optionally, a longitudinal center beam 300 extends between the front end-beam 108 and the rear end-beam 110 parallel to a longitudinal axis A₂₀₀ of the rocker rails 200 and separates the first battery cell 102a and the second battery cell 102b. The center beam 300 is not present in examples of the battery assembly 100 having only a single battery cell 102 (or single row of battery cells). Thus, the structural battery system 100 may include as few as six or seven structural components to form the frame or box of the battery assembly 100. Although described herein as a cell-to-body (CTB) system, the structural battery assembly 100 may be implemented as part of a cell-to-pack (CTP) or a CTB electric vehicle (EV) propulsion system.

Referring to FIGS. 2 and 2A, the first rocker rail 200a extends along the first side of the battery cells 102 and along the first side of the vehicle 10 and the second rocker rail 200b extends along the second side of the battery cells 102 and along the second side of the vehicle 10. Although one rocker rail 200 will be described further herein, it should be understood that the rocker rails 200 may have similar structures and features along both sides of the battery assembly 100.

As shown in FIG. 2A, the rocker rail 200 includes an extruded member, such as an extruded aluminum member, having a first side 202, a second side 204 opposite the first side 202, and an upper side 206 and a lower side 208 respectively extending between the first side 202 and the second side 204. One or more internal structural members 210 extend between the first side 202, the second side 204, the upper side 206, and the lower side 208. The first side 202 extends along and interfaces with the battery cell 102 and the second side 204 extends along an outer side of the vehicle 10. As discussed further below, the rocker rail 200 defines an internal venting chamber 212 bound by one or more of the first side 202, the second side 204, the upper side 206, the lower side 208, and one or more of the internal structural members 210.

One or more first vents or cell vents 214 is formed through the first side 202 and fluidly connects the venting chamber 212 and the battery cell 102. For example, the rocker rail 200 may include one or more cell vents 214 interfaced with each respective battery cell 102. Each cell vent 214 includes a first cell opening or port 216 formed through the first side 202 of the rocker rail 200 and a vent chimney 116 that extends from the battery cell 102 through the cell port 216 and along the cell vent 214 and at least partially into the venting chamber 212 to fluidly connect the venting chamber 212 and the battery cell 102. The vent chimney 116 and/or the battery cell 102 at and near the vent chimney 116 may be sealed to the first side 204 of the rocker rail 200, such as via a sealing element or gasket or adhesive member 118 circumscribing the vent chimney 116 between the first side 202 and the battery cell 102. A blast seal or cap 120, such as a mica cap, may extend over one or more openings of the vent chimney 116 for sealing the battery cell 102 during normal use. During thermal runaway, failure of the battery cell 102 may cause the blast seal 120 to burst, allowing hot gas, flames, and/or particulates (collectively referred to as exhaust) to flow from the battery cell 102 through the venting chimney 116 and the cell vent 214 into the venting chamber 212.

One or more second vents or pack vents 218 is formed through the lower side 208 and fluidly connects the venting chamber 212 and the ambient environment exterior the vehicle 10 at the lower side 208 of the rocker rail 200. For example, the rocker rail 200 may include one or more pack vents 218 corresponding to each respective battery cell 102a. Each pack vent 218 includes a second pack opening or port 220 formed through the lower side 208 of the rocker rail 200 and a vent plug or nozzle 222 that extends along the pack vent 218, at least partially within the venting chamber 212, and outward from the lower side 208 to fluidly connect the venting chamber 212 exterior of the vehicle 10.

The extruded rocker rail 200 includes one or more baffles or plates or screens 224 within the venting chamber 212 between the cell vent 214 and the pack vent 218 to muffle or diffuse the exhaust expelled by the battery cell 102. For example, and as shown in FIG. 2A, passages 226 are formed through the baffles 224 and the baffles 224 extend between the lower side 208 and internal structures 210 to separate or isolate or define fluidly-connected tumble regions 228 of the venting chamber 212. That is, the baffles 224 and other structure of the rocker rail 200 provide tumble-inducing geometry to enhance cooling of the exhaust and encourage collection of particulate within the tumble regions 228 as the exhaust flows through the venting chamber 212 and out the pack vent 218. Further, the cell vents 214 and the pack vents 218 are axially offset from one another along the longitudinal axis A₂₀₀ of the rocker rail 200 to provide additional muffling or baffling of the exhaust within the venting chamber 212.

Portions of the extruded rocker rail 200, such as internal structures 210 and a portion of the upper side 206 at or near the cell vent 214, may have a greater thickness to reduce or eliminate risk of melting of the rocker rail 200 at those portions during a failure event. For example, a portion of the upper side 206 between the venting chamber 212 and high voltage (HV) bussing or electrical connections 122 of the battery cell 102 is thicker or reinforced to isolate the exhaust from the HV bussing 122, which reduces or eliminates risk of HV arcing and spread of thermal runaway to additional battery cells 102.

Thus, the rocker rails 200 include the venting chamber 212 to provide passage of exhaust between the battery cells 102 and the ambient environment exterior the vehicle 10. Passage between the cell vent 214 and the pack vent 218 includes a series of vented walls to create a baffle or muffler to diffuse jet energy and drop particles. These baffle passages are integrated with the structural side-beams 200 to isolate gasses from the HV bussing 122 and reduce HV arcing risk. Further, each side-beam 200 includes a crushing structure or crush zone 230 at the second side 204 so that the side-beam 200 may provide rocker rail functionality. In other words, the rocker rails 200 provide side-crash progressive wall stiffness to form an inboard effective basin.

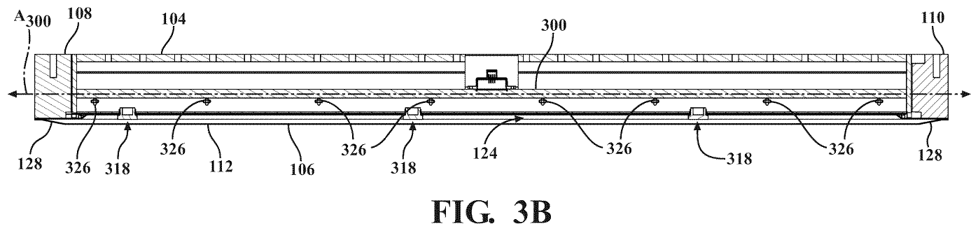

Referring to FIGS. 2B, 3A, and 3B, the longitudinal center beam 300 may provide similar venting functionality as the side-beams 200 to an opposite side or central region of the battery cells 102. In examples with two or more rows of battery cells 102, the center beam 300 extends along the second sides of the battery cells 102 opposite the rocker rails 200 between the front end-beam 108 and the rear end-beam 110, with a longitudinal axis A₃₀₀ of the center beam 300 parallel to the longitudinal axis A₂₀₀ of the rocker rails 200. The center beam 300 includes an extruded member, such as an extruded aluminum member, having a first side 302, a second side 304 opposite the first side 302, and an upper side 306 and a lower side 308 respectively extending between the first side 302 and the second side 304. One or more internal structures 310 may extend between the first side 302, the second side 304, the upper side 306, and the lower side 308. The first side 302 extends along and interfaces with the first battery cell 102a and the second side 304 extends along and interfaces with the second battery cell 102b. As discussed further below, the center beam 300 defines a central venting chamber 312 bound by one or more of the first side 302, the second side 304, the upper side 306, the lower side 308, and one or more of the internal structural members 310.

One or more cell vents 314 are formed through the first side 302 for fluidly connecting the central venting chamber 312 and the first battery cell 102a and one or more cell vents 314 are formed through the second side 304 for fluidly connecting the central venting chamber 312 and the second battery cell 102b. Each cell vent 214 includes a cell opening or port 316 formed through the respective side of the center beam 300 and a vent chimney 116 that extends from the battery cell 102 through the cell port 316 and along the cell vent 314 and at least partially into the central venting chamber 312 to fluidly connect the venting chamber 312 and the battery cell 102.

One or more pack vents 318 are formed through the lower side 308 and fluidly connect the central venting chamber 312 and the ambient environment exterior the vehicle 10 at the lower side 308 of the center beam 300. Each pack vent 318 includes a pack opening or port 320 formed through the lower side 308 of the center beam 300 and a vent plug 322 that extends along the pack vent 318 and at least partially within the venting chamber 312 and outward from the lower side 308 to fluidly connect the venting chamber 312 exterior of the vehicle 10.

The extruded center beam 300 includes one or more baffles 324 within the central venting chamber 312 between each cell vent 314 and the pack vent 318 to muffle or diffuse the exhaust expelled by the battery cell 102. The baffles 324 include passages 326 formed therethrough and the baffles 324 separate or isolate or define fluidly-connected tumble regions 328 of the central venting chamber 312. Further, the cell vents 314 and the pack vents 318 (and the passages 326 through the baffles 324) are axially offset from one another along the longitudinal axis A₃₀₀ of the center beam 300 to provide additional muffling or baffling of the exhaust within the central venting chamber 312 (FIGS. 3A and 3B). Portions of the extruded center beam 300 have a greater thickness to reduce or eliminate risk of melting of the center beam 300 during thermal runaway. For example, a portion of the internal structure 310 between the central venting chamber 312 and the HV bussing 122 of the battery cells 102 is thicker or reinforced to isolate the exhaust from the HV bussing 122.

Thus, the center beam 300 together with the rocker rails 200 provide exhaust passages between the battery cells 102 and the ambient environment, which reduces or eliminates the effect of thermal runaway at one battery cell 102 on additional battery cells 102 within the battery assembly 100. Further, the center beam 300 and the rocker rails 200 structurally support the battery cells 102 for mounting at the vehicle 10. For example, the rocker rails 200 include a ledge or lip 232 extending from the first side 202 for supporting a lower surface of the battery cell 102, and the center beam 300 also includes ledges or lips 332 extending from the first side 302 and the second side 304 for supporting the lower surfaces of both battery cells 102.

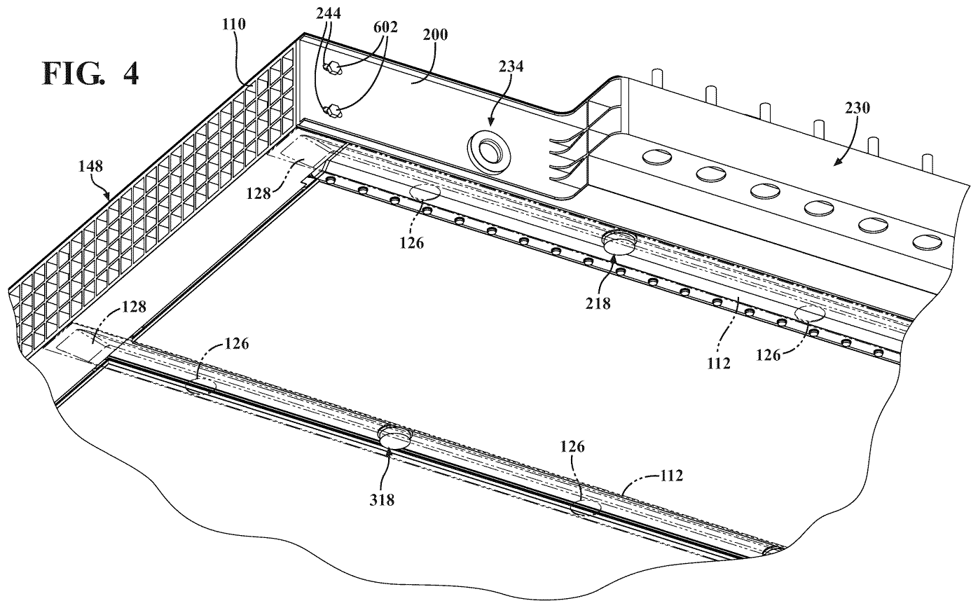

As shown in FIGS. 2-4, the pack vents 218 of the rocker rails 200 and the pack vents 318 of the center beam 300 are fluidly connected to respective exhaust chambers 124 formed along the skid rails 112 of the lower panel 106. That is, respective skid rails 112 of the lower panel 106 that extend along the longitudinal axis A₂₀₀ of the rocker rails 200 and that extend along the longitudinal axis A₃₀₀ of the center beam 300 define exhaust chambers 124 that are fluidly connected to the respective venting chamber 212 and central venting chamber 312 via the pack vents 218 of the rocker rails 200 and the pack vents 318 of the center beam 300. Respective ports or openings 126 are formed through the skid rails 112 for fluidly connecting the exhaust chambers 124 to the ambient environment, and the openings 126 are axially offset from the respective pack vents 218, 318. Terminal ends 128 of the skid rails 112 may be sealed or closed to ensure that exhaust is directed from the pack vents 218, 318 and outward from the openings 126 to direct the exhaust downward. Thus, when exhaust is directed from the pack vents 218, 318, the exhaust is further muffled within the exhaust chamber 124 of the skid rails 112, such as to reduce heat and particulates of the exhaust from reaching the ambient environment and thus reducing or eliminating risk of heat and particulates from affecting grass, oil, and/or roadway beneath the vehicle 10.

Further, the skid rails 112 may provide protection for the battery assembly 100 and lower surfaces of the vehicle 10 during low ground clearance situations. The terminal ends 128 of the skid rails 112 may be sloped or angled or curved or contoured to reduce risk of catching the skid rail 112 on obstacles beneath the vehicle 10 that could otherwise cause damage or removal of the skid rail 112.

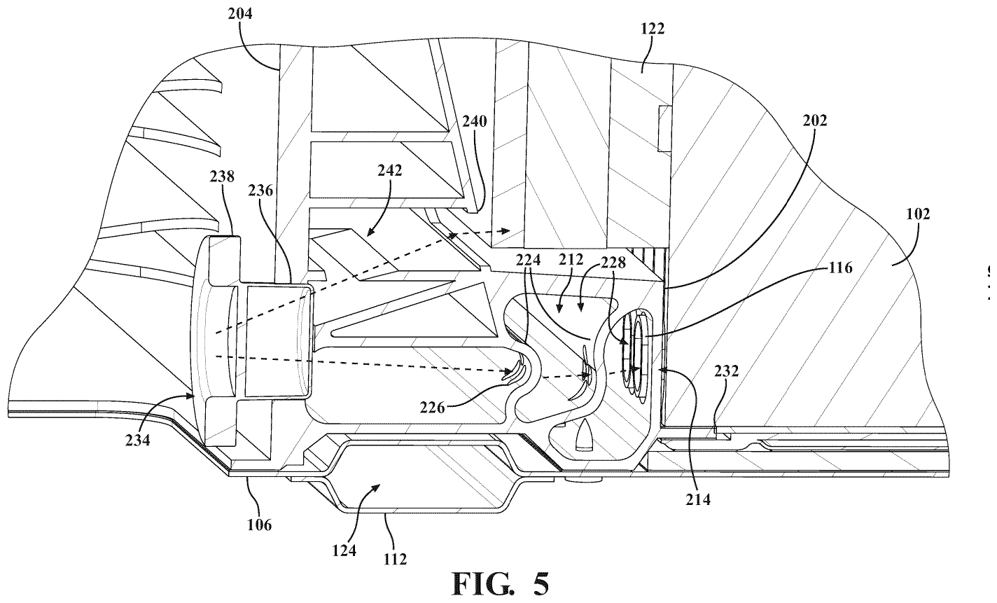

Referring to FIG. 5, a flood port 234 is formed through the second side 204 of the rocker rail 200 and fluidly connects the venting chamber 212 to the exterior of the vehicle 10 at the second side 204. For example, the flood port 234 may be accessible exterior of the vehicle 10, such as at a wheel well region of the vehicle 10. The flood port 234 includes an opening or through hole 236 formed through the second side 204 of the rocker rail 200 and a flood plug or nozzle 238 that extends along the flood port 234 and at least partially within the venting chamber 212 to fluidly connect the venting chamber 212 exterior of the vehicle 10 at the second side 204. The flood port 234 is configured to interface with a water source, such as a coupling end of a hose, for delivering water through the venting chamber 212 to the battery cell 102 during a failure event. For example, an emergency responder such as a firefighter may insert or attach the coupling end of a hose at the flood port 234 to extinguish and/or cool a battery cell 102 experiencing thermal runaway. Because the venting chamber 212 extends along the rocker rail 200, water may be delivered from the flood port 234 along the venting chamber 212 (and through respective passages 226 of the baffles 224) and through one or more cell vents 214 to extinguish and/or cool one or more of the battery cells 102.

In some examples, one or more third vents or bussing vents 240 are formed through the first side 202 and fluidly connect a flood chamber 242 and/or the venting chamber 212 of the extruded rocker rail 200 to the bussing region 122 of the battery cell 102. The flood port 234 fluidly connects the flood chamber 242 to the exterior of the vehicle 10 so that water can be delivered to the one or more bussing vents 240 and the one or more cell vents 214 simultaneously. Delivering water to the bussing regions 122 of the battery cells 102 provides enhanced cooling and further reduces spreading of thermal runaway between battery cells 102.

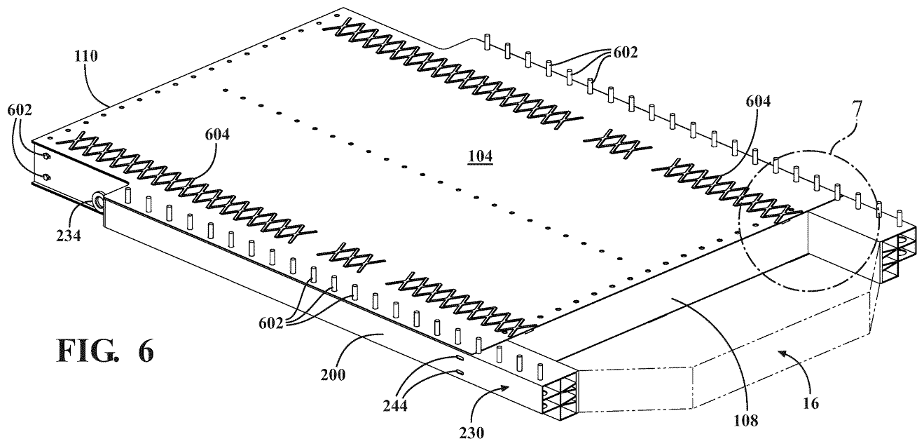

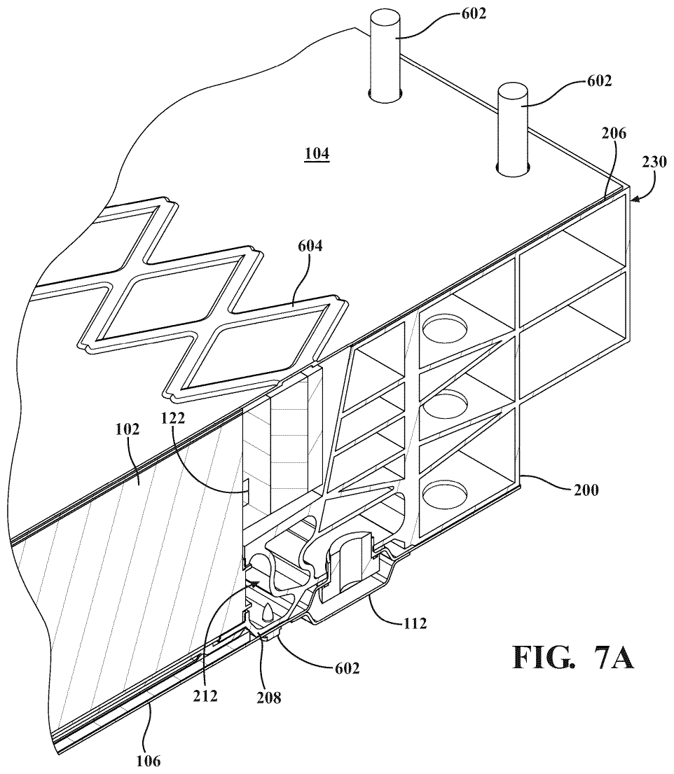

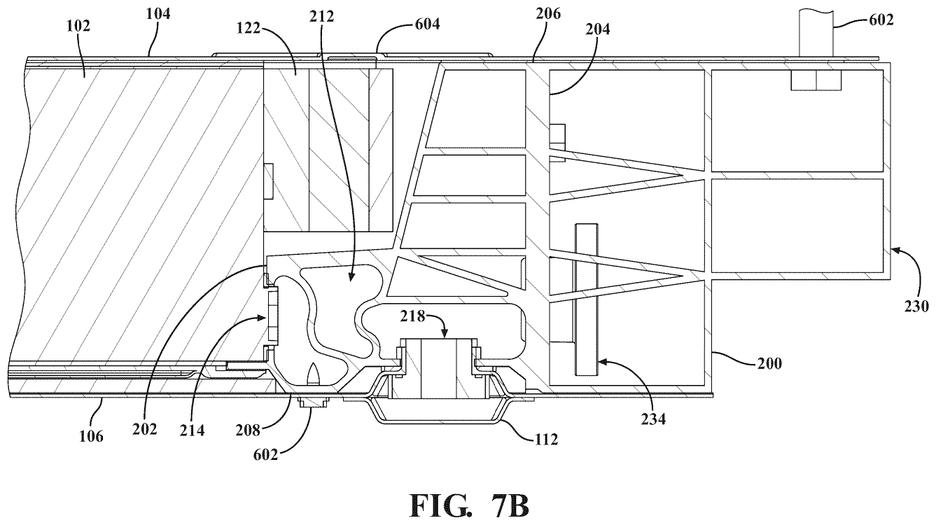

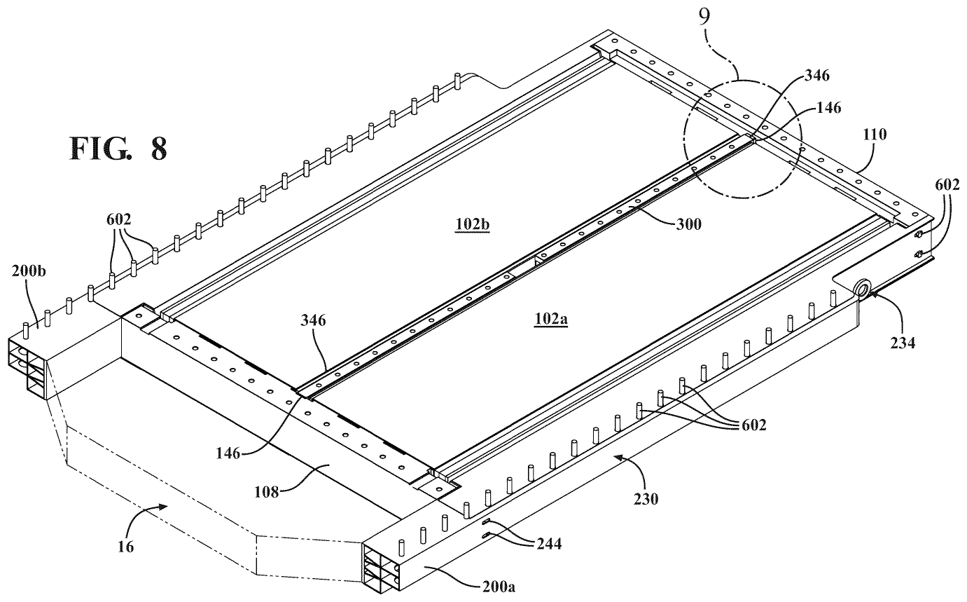

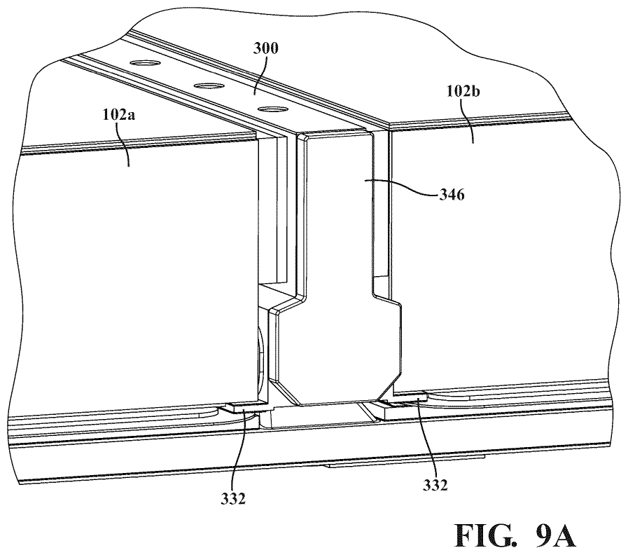

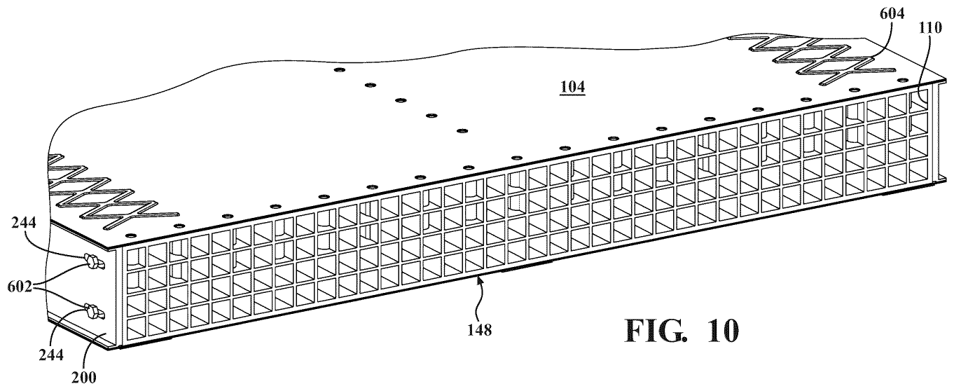

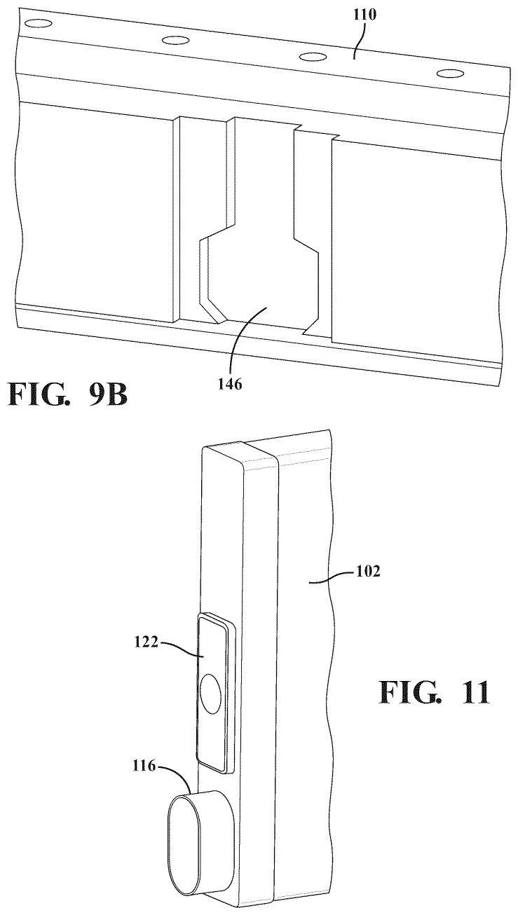

Referring now to FIGS. 1 and 6-10, because the side-beams 200 provide rocker rail functionality of the vehicle 10, structural integrity of the battery assembly 100 contributes to structural integrity and safety of the vehicle 10. Accordingly, the upper panel 104 that extends over and along the battery cells 102 and the center beam 300, and the lower panel 106 that extends under and along the battery cells 102 and the center beam 200 are coupled to the front end-beam 108, the rear end-beam 110 and the side-beams 200 to seal the battery assembly 100. For example, a plurality of mechanical fasteners 602, such as bolts or other suitable threaded fasteners, are disposed about the respective perimeter regions of the upper panel 104 and the lower panel 106 (and optionally along the center beam 300), to couple the upper panel 104 and lower panel 106 to the frame structure. The mechanical fasteners 602 coupling the lower panel 106 to the frame structure may be disposed as close as possible to the battery cell 102 to improve sealing of the battery cell compartment from the environment. For example, the mechanical fasteners 602 may extend through the lower panel 106 and the lower side 208 of the rocker rails 200 at least partially within the venting chamber 212 to form a tight seal between the lower panel 106 and the rocker rail 200 at or near as possible to the first side 204. This further encourages exhaust to flow through the cell vents 214 into the venting chamber 212.

Moreover, because at least a portion of the first side 204 of the rocker rail 200 may be spaced from the battery cell 102 to accommodate the bussing region 122, reinforcement 604, such as ribs or additional sheet metal like tailor-welded blanks, may be disposed or formed along the upper panel 104 at regions of the upper panel 104 corresponding to the bussing region 122. In other words, reinforcement ribs 604 extend along or within the upper panel 104 at areas corresponding to the bussing region 122 and between the rocker rail 200 and the battery cell 102. This helps prevent peeling of the upper panel 104 away from the rocker rail 200 and battery cell 102 in the event of a vehicle impact. The reinforcement ribs 604 may not be included at portions of the upper panel 104 corresponding to mounted components, such as the seat rails 12, so that the seat rails 12 may be rigidly bolted into the side-beams 200 and/or the center beam 300 through the upper panel 104.

To clamp the front end-beam 108 and the rear end-beam 110 between the rocker rails 200, one or more slots 244 are formed through the rocker rails 200 at corresponding mating positions for the end-beams. The front end-beam 108 and the rear end-beam 110 may each include cast structures, such as cast aluminum structures, with threaded holes formed at respective ends for receiving threaded fasteners 602 extending through the slots 244. The slots 244 accommodate component tolerances. That is, due to assembly sequence and adhesive thicknesses, mating the end-beams 108, 110 to the side-beams 200 after the battery cells 102 are disposed between the end-beams 200 and/or the center beam 300, allows the slots 244 to contain fore-aft stack-length variation. Width variations and, thus, distances between the battery cells 102 and the first side 202 of the side-beams may be accommodated by the cell chimneys 116.

With the front end-beam 108 and the rear end-beam 110 joined to the rocker rails 200, respective ends 346 of the center beam 300 are captured within respective pockets or recesses 146 formed at inner sides of the front end-beam 108 and the rear end-beam 110. That is, each of the front end-beam 108 and the rear end-beam 110 includes a respective recess 146 having a shape or profile that corresponds to a shape or profile of the end 346 of the center beam 300. For example, the center beam end 346 and the end-beam pocket 146 may form a geometric imprint or ball-socket joint with minimal clearance (e.g., 1 millimeter or less). This ensures that during a front or rear vehicle impact, load may be transferred through the center beam 300 even if the vehicle 10 is impacted at an angle or offset to the center beam 300, reducing transfer of the impact load to the battery cells 102. Further, the rear end-beam 110 may have a ribbed or pocketed structure at an outer surface to provide an impact-absorbing or crush zone 148.

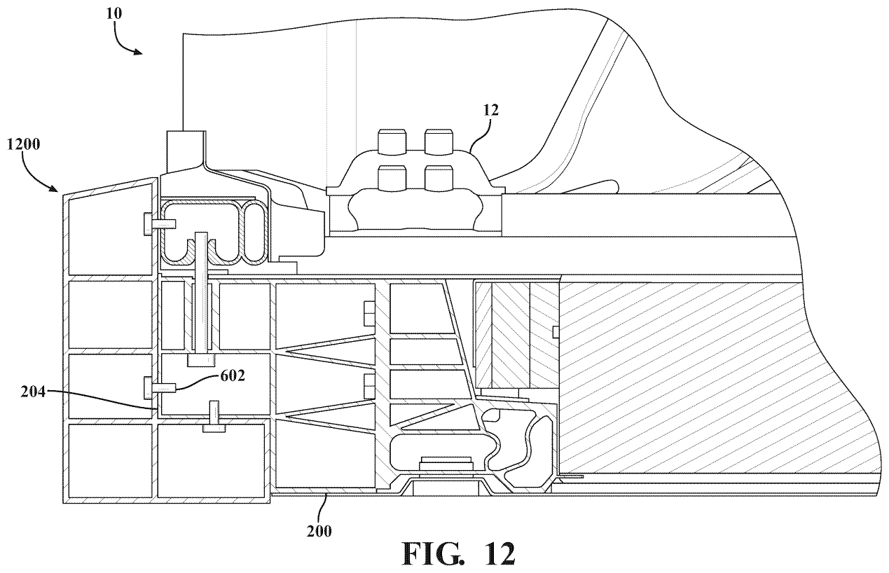

In some examples, and as shown in FIG. 12, a vehicular body member or rocker bumper 1200 may be mounted to the rocker rail 200 at the exterior of the vehicle 10. The rocker bumper 1200 mounts to the second side 204 of the rocker rail 200, such as at the crush zone 230, via threaded fasteners 602 or any suitable fastening means (e.g., clips, adhesive, and the like). Because the rocker rail 200 provides a structural component of the battery assembly 100, damage to the rocker rail 200 may result in substantial repairs. Accordingly, the rocker bumper 1200 is configured to absorb or attenuate low-intensity impacts at the side of the vehicle 10 and reduce or eliminate load transfer to the rocker rail 200. This allows the rocker bumper 1200 to be repaired and/or replaced following a vehicle impact and risk of damage to the rocker rail 200 is avoided.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicular rocker rail, the vehicular rocker rail comprising:
an extruded member configured for mounting at a vehicle equipped with the vehicular rocker rail, the extruded member comprising a first side, a second side opposite the first side, and an upper side and a lower side respectively extending between the first side and the second side, the first side, with the extruded member mounted at the vehicle, extends along a battery cell of the vehicle, and the extruded member defining a venting chamber;
a cell vent formed through the first side, the cell vent configured to, with the extruded member mounted at the vehicle, fluidly connect the battery cell and the venting chamber; and
a pack vent formed through the lower side, the pack vent configured to, with the extruded member mounted at the vehicle, fluidly connect the venting chamber to an exterior of the vehicle at the lower side.

2. The vehicular rocker rail of claim 1, wherein the cell vent and the pack vent are spaced from one another along a longitudinal axis of the extruded member.

3. The vehicular rocker rail of claim 1, wherein the extruded member comprises one or more baffles within the venting chamber between the cell vent and the pack vent.

4. The vehicular rocker rail of claim 1, wherein, with the extruded member mounted at the vehicle, a vent chimney extends from the battery cell through the cell vent and at least partially into the venting chamber to fluidly connect the battery cell and the venting chamber.

5. The vehicular rocker rail of claim 1, further comprising a flood port formed through the second side, the flood port configured to, with the extruded member mounted at the vehicle, fluidly connect the venting chamber to the exterior of the vehicle at the second side.

6. The vehicular rocker rail of claim 5, further comprising a bussing vent formed through the first side, the bussing vent configured to, with the extruded member mounted at the vehicle, fluidly connect a bussing region at the battery cell to a flood chamber of the extruded member, the flood port further configured to, with the extruded member mounted at the vehicle, fluidly connect the flood chamber to the exterior of the vehicle at the second side.

7. The vehicular rocker rail of claim 1, wherein, with the extruded member mounted at the vehicle, the extruded member extends along a first side of the battery cell and the extruded member is connected to a front beam that extends along a front side of the battery cell, a rear beam that extends along a rear side of the battery cell, an upper panel that extends along an upper side of the battery cell, and a lower panel that extends along a lower side of the battery cell.

8. The vehicular rocker rail of claim 7, wherein the lower panel comprises a skid rail that, with the extruded member mounted at the vehicle, extends along a longitudinal axis of the extruded member, the pack vent configured to fluidly connect the venting chamber to an exhaust chamber of the skid rail.

9. The vehicular rocker rail of claim 7, wherein, with the extruded member mounted at the vehicle, a center beam extends along a second side of the battery cell opposite the first side of the battery cell, the center beam defining a central venting chamber and comprising a central cell vent configured to fluidly connect the battery cell and the central venting chamber and a central pack vent configured to fluidly connect the central venting chamber to the exterior of the vehicle at a lower side of the center beam.

10. The vehicular rocker rail of claim 1, wherein, with the extruded member mounted at the vehicle, a vehicular body member is mounted at the second side.

11. A vehicular battery assembly, the vehicular battery assembly comprising:
a battery cell configured to, with the vehicular battery assembly mounted at a vehicle equipped with the vehicular battery assembly, power a propulsion system of the vehicle;
a front beam that extends along a front side of the battery cell;
a rear beam that extends along a rear side of the battery cell opposite the front side of the battery cell;
an upper panel that extends along an upper side of the battery cell, the upper side of the battery cell extending between the front side and the rear side of the battery cell;
a lower panel that extends along a lower side of the battery cell opposite the upper side of the battery cell;
a first rocker rail that extends along a first side of the battery cell, the first side of the battery cell extending between the front side and the rear side of the battery cell;
a second rocker rail that extends along a second side of the battery cell opposite the first side of the battery cell; and
wherein the first rocker rail and the second rocker rail each respectively comprise:
an extruded member comprising a first side, a second side opposite the first side, and an upper side and a lower side respectively extending between the first side and the second side, the first side extending along the respective side of the battery cell, and the extruded member defining a venting chamber;
a cell vent formed through the first side, the cell vent fluidly connecting the battery cell and the venting chamber; and
a pack vent formed through the lower side, the pack vent fluidly connecting the venting chamber to an exterior of the vehicle at the lower side of the extruded member.

12. The vehicular battery assembly of claim 11, wherein the cell vent and the pack vent are spaced from one another along a longitudinal axis of the extruded member.

13. The vehicular battery assembly of claim 11, wherein the extruded member comprises one or more baffles within the venting chamber between the cell vent and the pack vent.

14. The vehicular battery assembly of claim 11, wherein a vent chimney extends from the battery cell through the cell vent and at least partially into the venting chamber to fluidly connect the battery cell and the venting chamber.

15. The vehicular battery assembly of claim 11, wherein the first rocker rail and the second rocker rail each respectively comprise a flood port formed through the second side of the extruded member, the flood port fluidly connecting the venting chamber to the exterior of the vehicle at the second side of the extruded member.

16. The vehicular battery assembly of claim 15, wherein the first rocker rail and the second rocker rail each respectively comprise a bussing vent formed through the first side of the extruded member, the bussing vent fluidly connecting a bussing region at the battery cell to a flood chamber of the extruded member, the flood port fluidly connecting the flood chamber to the exterior of the vehicle at the second side of the extruded member.

17. The vehicular battery assembly of claim 11, wherein, with the vehicular battery assembly mounted at the vehicle, a respective vehicular body member is mounted at the second sides of the extruded members.

18. A vehicle, the vehicle comprising:
a battery assembly, the batter assembly comprising:
a battery cell that powers a propulsion system of the vehicle;
a front beam that extends along a front side of the battery cell;
a rear beam that extends along a rear side of the battery cell opposite the front side of the battery cell;
an upper panel that extends along an upper side of the battery cell, the upper side of the battery cell extending between the front side and the rear side of the battery cell;
a lower panel that extends along a lower side of the battery cell opposite the upper side of the battery cell;
a first rocker rail that extends along a first side of the battery cell, the first side of the battery cell extending between the front side and the rear side of the battery cell;
a second rocker rail that extends along a second side of the battery cell opposite the first side of the battery cell; and
wherein the first rocker rail and the second rocker rail each respectively comprise:
an extruded member comprising a first side, a second side opposite the first side, and an upper side and a lower side respectively extending between the first side and the second side, the first side extending along the respective side of the battery cell, and the extruded member defining a venting chamber;
a cell vent formed through the first side, the cell vent fluidly connecting the battery cell and the venting chamber; and
a pack vent formed through the lower side, the pack vent fluidly connecting the venting chamber to an exterior of the vehicle at the lower side.

19. The vehicle of claim 18, wherein the extruded member comprises one or more baffles within the venting chamber between the cell vent and the pack vent.

20. The vehicle of claim 18, wherein the lower panel comprises respective skid rails that extend along respective longitudinal axes of the extruded members, the respective pack vents fluidly connecting the venting chamber to respective exhaust chambers of the skid rails.
